(19) United States
(12) Patent Application Publication
(10) Pub. No.: US 2006/0206632 A1
(43) Pub. Date: Sep. 14, 2006

(54) Storage enclosure including a storage device capable of communicating with multiple controllers

(75) Inventors: Shane Chiasson, Pflugerville, TX (US); Paul Fuller, Georgetown, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/076,279

(22) Filed: Mar. 9, 2005

(51) Int. Cl. G06F 3/00

(52) U.S. Cl. 710/20

(57) ABSTRACT

A storage enclosure is provided which includes a first expander coupled to a first controller. The storage enclosure also includes a second expander coupled to a second controller and the first expander. The storage enclosure further includes a storage device, including a single interface, coupled to the first expander via the single interface. With the storage enclosure provided, the first controller is capable of communicating with the storage device via the first expander, and the second controller is capable of communicating with the storage device via the first expander and the second expander.

### BACKGROUND

The description herein relates generally to information handling systems (“IHSs”) and more particularly to storage enclosures including storage devices.

As the value and use of information continues to increase, individuals and businesses seek additional ways to process and store information. One option is an information handling system (“IHS”). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

A storage enclosure includes one or more storage devices (e.g., serial attached small computer systems interface (“SAS”) storage devices or serial advanced technology attachment (“SATA”) storage devices). The storage enclosure is capable of being coupled to multiple storage device controllers (e.g., controllers included in one or multiple IHSs) so that one or more of the storage devices are capable of communicating with the multiple controllers.

Some storage devices, such as a SATA storage device, include a single interface (e.g., A port) so that such devices are capable of being coupled to only a single controller. With a conventional technique, such storage devices are capable of being coupled to multiple controllers via a switch (e.g., a port selector). However, implementing such switch causes various problems including increased cost and complexity associated with including such switch in a storage device.

What is needed is a method and a storage enclosure including a storage device capable of communicating with multiple controllers, without the disadvantages discussed above.

### SUMMARY

Accordingly, a storage enclosure including a first expander coupled to a first controller is provided. The storage enclosure also includes a second expander coupled to a second controller and the first expander. The storage enclosure further includes a storage device, including a single interface, coupled to the first expander via the single interface. With the storage enclosure provided, the first controller is capable of communicating with the storage device via the first expander, and the second controller is capable of communicating with the storage device via the first expander and the second expander.

### BRIEF DESCRIPTION OF THE DRAWINGS

FIG. 1 is a block diagram of a storage enclosure coupled to multiple information handling systems according to an illustrative embodiment.

FIG. 2 is a block diagram of an information handling system of FIG. 1.

FIG. 3 is a block diagram of the storage enclosure of FIG. 1.

FIG. 4 is a flow chart of operations performed for communicating with a storage device included in the storage enclosure of FIG. 3.

### DETAILED DESCRIPTION

For purposes of this disclosure, an information handling system (“IHS”) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (“CPU”) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

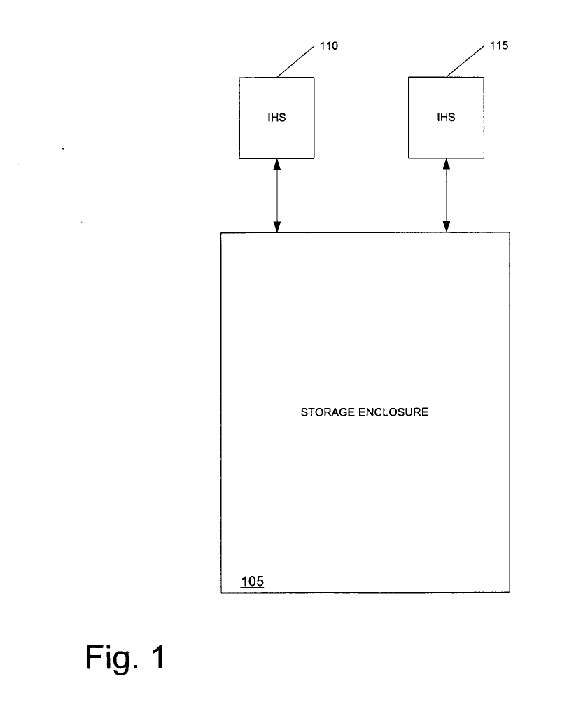

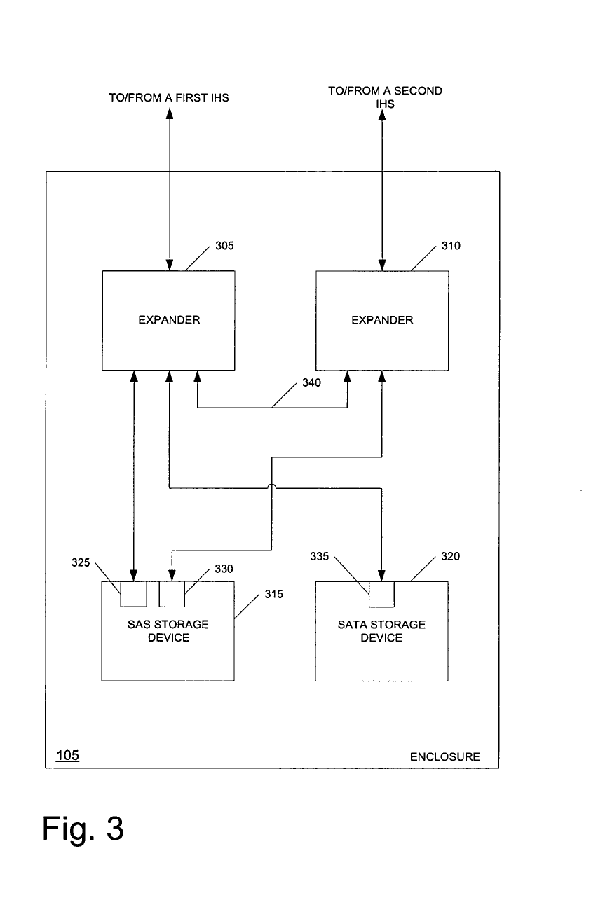

FIG. 1 is a block diagram of a storage enclosure 105 coupled to multiple IHSs 110, and 115. As discussed below in more detail (in connection with FIG. 3), the storage enclosure 105 is coupled to the IHSs 110 and 115 via such IHSs′ respective storage device controllers. Also, although FIG. 1 depicts only the IHSs 110 and 115, the storage enclosure 105 is capable of being coupled to additional IHSs that are similar to the IHSs 110 and 115.

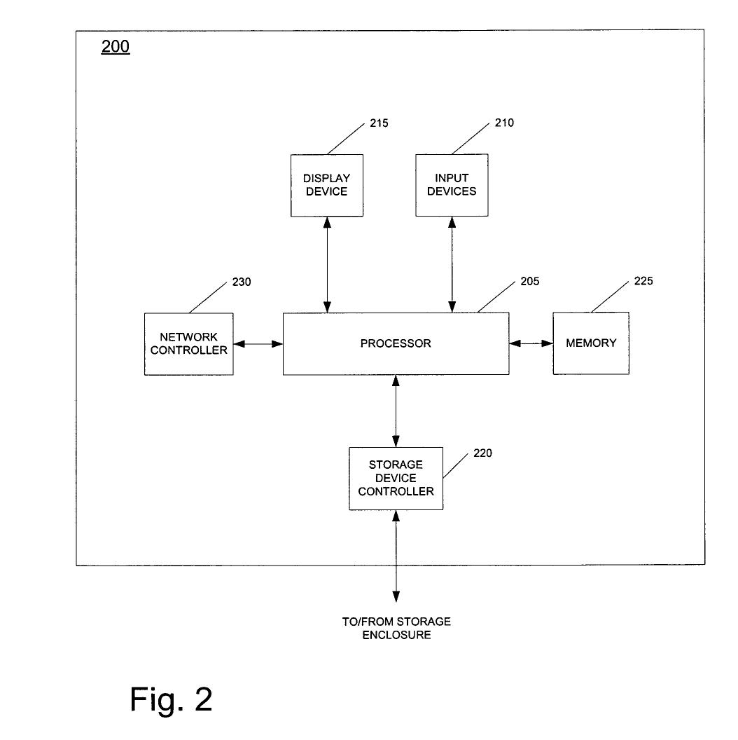

FIG. 2 is a block diagram of an IHS, indicated generally at 200, according to the illustrative embodiment. The IHS 200 includes a processor 205 (e.g., an Intel Pentium series processor) for executing and otherwise processing instructions, input devices 210 for receiving information from a human user, a display device 215 (e.g., a cathode ray tube (“CRT”) device, a projector, a liquid crystal display (“LCD”) device, or a plasma display device) for displaying information to the user, a memory device 225 (e.g., random access memory (“RAM”) device and read only memory (“ROM”) device), for storing information, and a network controller 230 for communicating between the IHS 200 and a network. Each of the input devices 210, the display device 215, the memory device 225, and the network controller 230 is coupled to the processor 205, and to one another. In one example, the IHS 200 includes various other electronic circuitry for performing other operations of the IHS 300, such as a print device (e.g., an ink-jet printer or a laser printer) for printing visual images on paper.

The input devices 210 include, for example, a conventional keyboard and a pointing device (e.g., a “mouse”, a roller ball, or a light pen). A user operates the keyboard to input alphanumeric text information to the processor 205, and the processor receives such information from the keyboard. A user also operates the pointing device to input cursor-control information to the processor 205, and the processor 105 receives such cursor-control information from the pointing device.

In the illustrative embodiment, the IHS 200 is a server. For providing the IHS 200 with access to a storage device (e.g., a storage device included by a storage enclosure), the IHS 200 includes a storage device controller (e.g., a SAS controller) 220. Via the controller 220, the IHS 200 is coupled to a storage enclosure as discussed in more detail below in connection with FIG. 3.

FIG. 3 is a block diagram of the storage enclosure 105 of FIG. 1. As discussed above, the storage enclosure 105 is coupled to a plurality of IHSs via such IHSs' respective controllers. More specifically, such controllers of the IHSs are coupled to expanders included in the storage enclosure 105. Accordingly, the storage enclosure 105 includes an expander (e.g., a SAS expander) 305, which is coupled to a first IHS (e.g., the IHS 110 of FIG. 1) and an expander 310, which is coupled to a second IHS (e.g., the IHS 115 of FIG. 1).

As discussed in more detail below, an expander (e.g., the expanders 305 and 310) is capable of being coupled to one or more IHSs (e.g., via one or more controllers), one or more storage devices, and/or one or more other expanders. Via such expander, each of the IHSs is capable of communicating with such storage devices and/or other expanders.

The storage enclosure 105 also includes storage devices (e.g., disk drives) 315 and 320. In one example, the storage device 315 is a SAS storage device, which is capable of including a plurality of interfaces (e.g., ports). Accordingly, the storage device 315 includes interfaces 325 and 330 so that the storage device 315 is capable of communicating with (e.g., outputting information to and receiving information from) a plurality of IHSs or controllers included in such IHSs.

In the example, the storage device 320 is a SATA storage device. Accordingly, the storage device 320 includes a single interface 335. As discussed above, with a conventional technique, multiple IHSs (or multiple controller included in such IHSs) are capable of communicating with the storage device 320 if a switch such as a SAS port selector is coupled between the storage device 320 and such multiple IHSs. However, in the illustrative embodiment, multiple IHSs are capable of communicating with the storage device 320 even if a port selector is not coupled between the storage device 320 and the multiple IHSs as discussed below.

For clarity, the following discussion references the storage device 315 as a SAS storage device 315. Also for clarity, the discussion references the storage device 320 as a SATA storage device 320.

As shown in FIG. 3, the expander 305 is coupled to the SAS storage device 315 via the interface 325. Accordingly, the first IHS coupled to the expander 305 is capable of communicating with the SAS storage device 315 via the expander 305. Similarly, the expander 310 is coupled to the SAS storage device 315 via the interface 330. Accordingly, the second IHS coupled to the expander 310 is capable of communicating with the SAS storage device 315 via the expander 310.

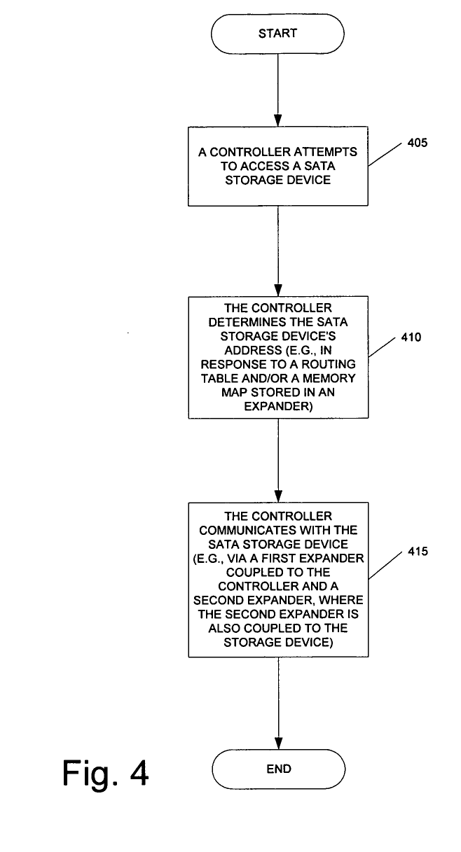

The expander 305 is also coupled to the SATA storage device 320 via the single interface 335 so that the first IHS is capable of communicating with the SATA storage device 320 via the expander 305. Moreover, the expander 305 and the expander 310 are coupled to one another via a communications link 340 so that the second IHS is capable of communicating with the SATA storage device 320 via the expander 310 and the expander 305 as discussed in more detail below in connection with FIG. 4.

Accordingly, FIG. 4 is a flow chart of operations performed by second IHS′ controller for communicating with the SATA storage device 320. The operation begins at a step 405, where the controller attempts to access the SATA storage device 320. After the step 405, the operation continues to a step 410.

At the step 410, the controller determines the SATA storage device 320's address. In one example, the controller determines such address in response to a routing table and/or a memory map stored in the expander 310. After the step 410, the operation continues to a step 415.

At the step 415, the controller communicates with the SATA storage device 320 at the address determined in the step 410. As discussed above, the controller communicates with the SATA storage device 320 via the expander 310 and the expander 305. After the step 415, the operation ends as shown.

The above discussions (in connection with FIGS. 1, 2, 3, and 4) reference the SATA storage device 320 as being capable of communicating with multiple IHSs via multiple controllers respectively included therein. However, in another embodiment, such multiple controllers are included in a common IHS. Accordingly, in such embodiment, the SATA storage device 320 is capable of communicating with multiple controllers included by a common IHS.

Although illustrative embodiments have been shown and described, a wide range of modification, change and substitution is contemplated in the foregoing disclosure. Also, in some instances, some features of the embodiments may be employed without a corresponding use of other features. Accordingly, it is appropriate that the appended claims be constructed broadly and in manner consistent with the scope of the embodiments disclosed herein.

What is claimed is:

1. A storage enclosure comprising:
a first expander coupled to a first controller;
a second expander coupled to a second controller and the first expander; and
a storage device, including a single interface, coupled to the first expander via the single interface, wherein the first controller is capable of communicating with the storage device via the first expander, and the second controller is capable of communicating with the storage device via the first expander and the second expander.

2. The storage enclosure of claim 1, wherein the storage device is a serial advanced technology attachment (“SATA”) storage device.

3. The storage enclosure of claim 1, wherein the first controller is included in a first information handling system (“IHS”) and the second controller is included in a second IHS.

4. The storage enclosure of claim 1, wherein the first controller and the second controller are included in a common IHS.

5. The storage enclosure of claim 1, wherein the second controller is capable of communicating with the storage device by determining an address associated with the storage device and communicating with the storage device at the address.

6. The storage device of claim 5, wherein determining the address includes:
determining the address in response to a routing table.

7. The storage enclosure of claim 6, wherein the routing table is stored in the second expander.

8. The storage device of claim 5, wherein determining the address includes:
determining the address in response to a memory map.

9. The storage enclosure of claim 1, and comprising:
a serial attached small computer systems interface (“SAS”) storage device, coupled to the first expander and the second expander.

10. The storage enclosure of claim 1, wherein the first controller and the second controller are SAS controllers.

11. A method comprising:
providing a storage enclosure;
providing a first expander, included in the storage enclosure, coupled to a first controller;
providing a second expander, included in the storage enclosure, coupled to a second controller and the first expander; and
providing a storage device, included in the storage enclosure, coupled to the first expander, wherein the first controller is capable communicating with the storage device via the first expander, and the second controller is capable of communicating with the storage device via the first expander and the second expander.

12. The method of claim 11, wherein the storage device is a serial advanced technology attachment (“SATA”) storage device.

13. The method of claim 11, wherein the first controller is included in a first information handling system (“IHS”) and the second controller is included in a second IHS.

14. The method of claim 11, wherein the first controller and the second controller are included in a common IHS.

15. The method of claim 11, wherein the second controller is capable of communicating with the storage device by determining an address associated with the storage device and communicating with the storage device at the address.

16. The storage device of claim 15, wherein determining the address includes:
determining the address in response to a routing table.

17. The method of claim 16, wherein the routing table is stored in the second expander.

18. The method of claim 15, wherein determining the address includes:
determining the address in response to a memory map.

19. The method of claim 11, wherein the storage enclosure includes a serial attached small computer systems interface (“SAS”) storage device, coupled to the first expander and the second expander.

20. The method of claim 11, wherein the first controller and the second controller are SAS controllers.
